(19) United States
(12) Patent Application Publication
(10) Pub. No.: US 2004/0199549 A1
(43) Pub. Date: Oct. 7, 2004

(54) Method and system for performing concurrency control in a relational database

(76) Inventor: Kenneth Oksanen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/480,274

(22) PCT Filed: Jun. 25, 2001
(86) PCT No.: PCT/EP01/07194

(51) Int. Cl. G06F 12/00

(52) U.S. Cl. 707/201

(57) ABSTRACT

The present invention relates to a method and a system for performing concurrency control in a relational database. A checklist of read and/or write events served during a transaction is generated, and concurrent checklists are analyzed to determine whether they can be serialized. The transaction is then commited based on the result of said analyzing step. Thus, nothing is written to the database by the transactions when they obtain elements from the database, such that concurrency control is possible for system employing a copy-on-write policy.

### FIELD OF THE INVENTION

The present invention relates to a method and system for performing concurrency control in a relational database to isolate concurrent accesses to the database while allowing allowing as much as possible concurrent accesses to different parts of the database.

### BACKGROUND OF THE INVENTION

Database systems comprise a large amount of mainly disk-resident data and a server which processes efficiently and reliably various Structured Query Language (SQL) transactions, such as money transfer orders and account balance queries.

Most database management systems have a layered structure. Assuming a three-layer division of a traditional database manager, the lowest layer performs disk input/output, provides media recovery, e.g. by mirroring or RAID, and crash recovery, e.g. with logs and periodic checkpointing. The second layer implements index structures, e.g. B-trees, on top of the primitives provided by the lower level. The highest level builds a data model abstraction on top of the index structures, interprets the query language, e.g. SQL, and communicates with the clients of the database.

An imperative implementation of tree-like data structures can usually be rather easily translated to its functional counter part. If a leave node is modified, the path from the leave to the route is copied yielding a new route. In N. Sarnac and R. E. Tarian, “Planar Point Location Using Persistent Search Trees”, Communications of the RCM, 29(7):669-679, July 1986, this general technique is called path copying when implementing persistent data structures.

In traditional database management systems, perform updates-in-place are performed and logs and periodic checkpointing are used to efficiently achieve atomicity and durability. The fundamental tools of typical concurreny control mechanisms include locks, updates-in-place, and possibly timestamps. However, in the initially described database management systems a copy-on-write policy is used, where transactions are entirely isolated from each other. Thus, none of the known concurrency control mechanisms can be applied.

### SUMMARY OF THE INVENTION

It is therefore an object of the present invention to provide a method and a system for performing a concurrency control in a database system using copy-on-write policy.

This object is achieved by a method for performing concurrency control in a relational database, said method comprising the steps of:

obtaining a snapshot of said database for a transaction;

generating a checklist of read and/or write events served during a transaction;

analyzing concurrent checklists to determine whether they can be serialized;

committing said transaction based on the result of said analyzing step; and

generating a new snapshot of said database based on the result of said committing step.

Furthermore, the above object is achieved by a system for performing concurrency control in a relational database, said system comprising:

managing means for maintaining said relational database based on transaction statements received from clients; and

transaction means for generating a checklist of read and/or write events served during a transaction, and for sending said checklist to said managing means if said transaction request is to be comitted;

wherein said managing means is arranged to analyze concurrent checklists to determine whether they can be serialized, and to commit said transaction based on the result of said analyzing step.

Accordingly, a number of server threads in the database system receive read and update requests related to a transaction. The server thread builds a checklist of the corresponding read and write events served during the transaction. When the transaction is to be committed, the checklist collected by the thread is sent to a merging process. The merging process analyses all concurrent checklists and determines whether they can be serialized. Hence, nothing is written to the database by the transactions when they obtain elements from the database. No lock flags are set in the database and no timestamps are written to database elements. Therefore, concurrency control can be provided even in copy-on-write systems.

Preferably, the analyzing step is based on a checking operation as to whether database elements mentioned In said concurrent checklists are consistent. This consistency may be given if the database elements mentioned in the checklist do not overlap or if they have no illegal relationships, i.e. they comply to the ACID requirement of databases. In particular, the checking operation may be based on database element identifies and/or timestamps collected to said concurrent checklists.

Furthermore, a snapshot of the relational database may be requested for read-only transactions, and an updated snapshot may be returned for updating transactions, while the snapshot requests are stored in a snapshot request queue.

In an autocommit mode, a snapshot may be requested in an exclusive mode for an updating transaction request, and a generated snapshot may be sent to the first entry of the snapshot request queue. Preferably, incoming checklists are queued until no transaction uses said database in an exclusive mode.

The concurrent checklists may be validated against a current database snapshot. Thereby consistency can be checked. The committing step may then comprise the steps of updating said current database snapshot and reporting successful commitment. In particular, the manager means may be arranged to validate said concurrent checklists against a current database snapshot, to perform an update of said current snapshot, to discard the old snapshot, and to report successful commitment, if it has not detected any conflict. Additions to the checklist may be discarded if said checklist exceeds a predetermined length.

Advantageous further developments of the invention are subject of the appended dependent claims.

### BRIEF DESCRIPTION OF THE DRAWINGS

In the following, the present invention will be described in greater detail in accordance with a preferred embodiment thereof and with reference to the accompanying drawings, in which:

FIG. 1 schematically shows a thread organization of an SQL-based server of a relational database system;

FIG. 2 shows a schematic diagram of a concurrency control function in a manager thread according to the preferred embodiment of the present invention; and

FIG. 3 shows a schematic database tree and a successive process of allocating new cells according to the preferred embodiment.

### DESCRIPTION OF THE PREFERRED EMBODIMENTS

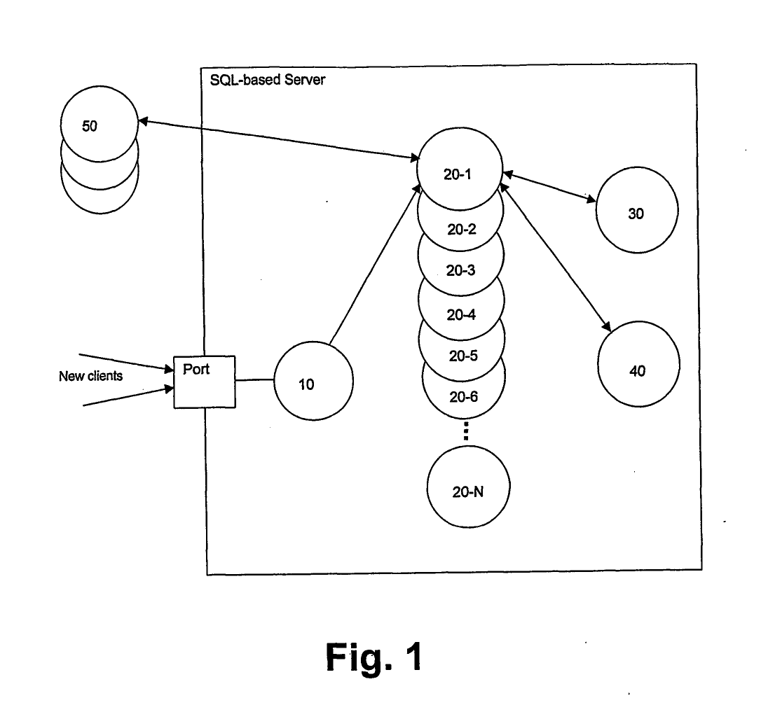

The preferred embodiment will now be described with reference to a thread organisation of an SQL-based server as shown in FIG. 1.

As shown in FIG. 1, an acceptor thread 10 is arranged to listen to a port for new connections from clients and spawns a client thread for each connection. The client or transaction threads 20-1 to 20-N communicate with the existing clients 50 using a language such as ODBC and represent the transactions to a manager thread 30 which in turn maintains the current state of the database and imposes a concurrency control among the transactions.

Furthermore, a preparer thread 40 is provided, which receives new SQL statements and compiles, or prepares in ODBC parleance, the SQL statements into a structure, typically a forest of partially applied lambda functions, which can then be applied to perform the actions or transactions according to the SQL statement.

The functionality of the preparer thread 40 may as well be incorporated in each of the transactions threads 20-1 to 20-N, but this would lead to the disadvantage that all of the possibly hundreds of connections would compile the SQL statement. By moving the compilation to the separate preparer thread 40, the compilation of each distinct SQL statement has to be done only once in the entire server.

According to the preferred embodiment, concurrency control is achieved by merging changes performed by different transactions.

In case of a read-only transaction in an autocommit mode, the corresponding one of the transaction threads 20-1 to 20-n initially sends to the manager thread 30 a request message for a snapshot of the database, which is immediately delivered by the manager thread 30 in a reply message. When the transaction is finished, the snapshot is simply forgotten, and will be removed or collected away by a garbage collection function.

Updating transactions in the autocommit mode are executed serially, wherein the respective transaction thread requests from the manager thread 30 a snapshot of the database in an exclusive mode. The manager thread 30 queues such exclusive snapshot requests and sends the snapshot to the first entry of the snapshot request queue. In turn each updating transaction thread performs ist updates to the database and returns a correspondingly updated snapshot to the manager thread 30. It is noted that a transaction-consistent snapshot can be sent to read-only transactions even if an updating transaction is in process.

In case of a manual mode transaction, the respective transaction thread requests a non-exclusive snapshot.

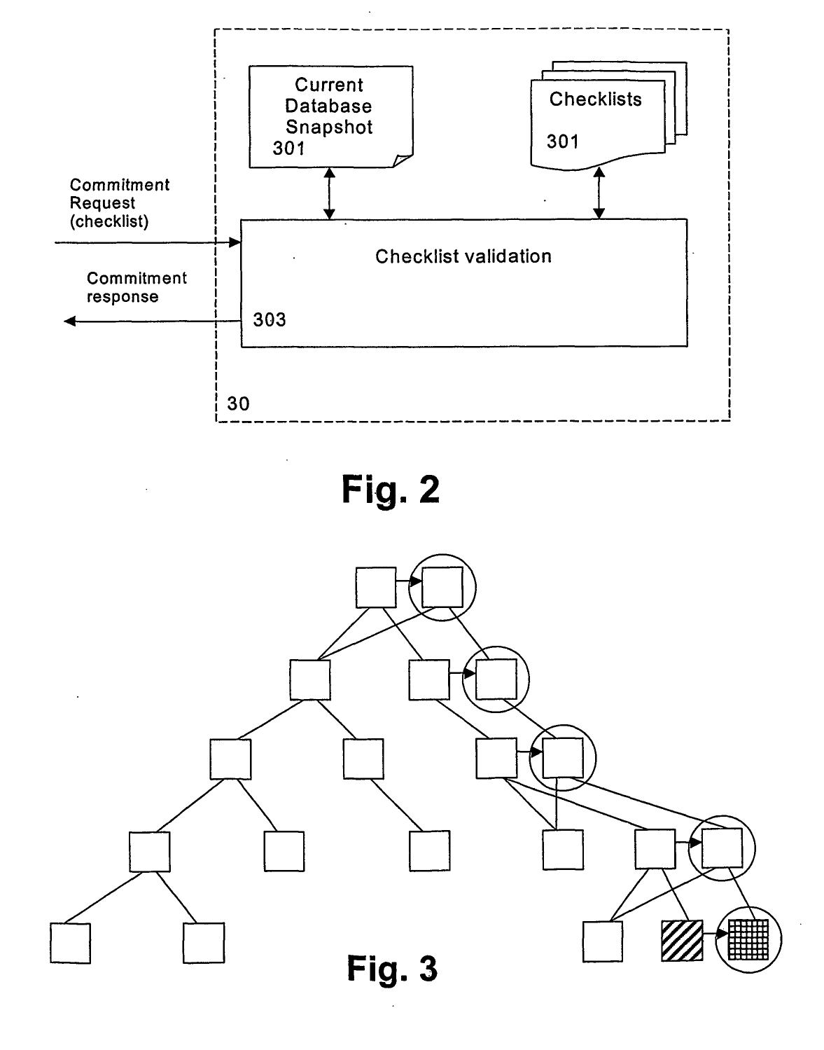

FIG. 2 shows a schematic block diagram of the functions of the manager thread 30 for achieving a corresponding concurrency control procedure. The respective transaction thread maintains a checklist of all operations and data it has performed. In particular, the checklist comprises information about the values stored for a certain key, the values read and sent to a client, the keys which have been deleted, and other suitable information specifying transactions. If the respective transaction thread requests to commit the transaction, a request for commitment is issued or sent to the manager thread 30, as indicated in FIG. 2. Together with the commitment request the checklist relating to the transaction is forwarded to the manager thread 30 which queues incoming checklists in a checklist queue 301 until no transaction uses the database in an exclusive mode. The manager thread 30 comprises a checklist validation functionality 303 for validating the checklists against a current database snapshot 301 which may be stored in the database or a corresponding memory or register. If no conflict is determined by the checklist validation functionality 303, the manager thread 30 performs the concerned updates to the current database snapshot 301, discards the old or former database snapshot, and reports successful commitment e.g. by issuing a commitment response to the respective transaction thread. On the other hand, if a conflict is determined by the checklist validation functionality 303, the manager thread 30 reverts the old database snapshot and reports failure to commit to the respective transaction thread.

If the manual mode transaction is aborted, the corresponding checklist and modified database snapshot are simply forgotten, e.g. will be deleted. Similarly, if the checklist becomes excessively long, i.e. exceeds a predetermined threshold, e.g. because a the transaction relates to a data selection operation with a large result set, the transaction is doomed to abort or roll back and further additions to the checklist are discarded.

As an example, a simplified database snapshot DB1 of key-value pairs (a, 1), (b, 2) and (c, 3) is assumed. This database snapshot DB1 is sent to two manual mode transaction threads. While they are updating their snapshots and generating their checklists, an autocommit mode transaction leads to a successful update of the database to DB2=(a, 1), (b, 2), (c, 4). Now, the first manual transaction requests commitment by sending its checklist [(read, b, 2), (write, a, 5)] to the manager thread 30, denoting that the respective transaction thread has informed the client that key b contains the value “2” and that the value of key a has been updated to “5”. Using the checklist validation functionality 303, the manager thread 30 checks whether the read performed according to the received checklist matches to the database snapshot DB2, which is indeed the case. Then, it updates the current database snapshot DB2 to become DB3=(a, 5), (b, 2), (c, 4) and a successful commit is reported to the transaction thread of the first transaction. Next, it is assumed that the second manual mode transaction requests commitment by sending the checklist [(write, a, 6), (read, c, 3)] to the manager thread 30. The update of the key a to the value “6” yields DB4=(a, 6), (b, 2), (c, 4). Now, the next operation validating that the value of key c is still “3” fails, because the value of the key c has been updated to “4” while the second manual mode transaction had been active. Due to the fact that the actions or events of the second manual mode transaction were dependent on the result of reading the key c, the transaction had proceeded in a conflicting way. The manager thread 30 thus reverts back to snapshot DB3 and reports abort of the transaction to the transaction thread of the second manual mode transaction.

Thus, in the present concurrency control scheme, each transaction operates in its own database snapshot which it can freely modify for itself. Furthermore, the checklists are sent to the manager thread 30 which modifies its its own database version (snapshot) accordingly. Thus, the concurrency control scheme is particularly suitable for implementation in a pure functional programming environment.

FIG. 3 shows an example for a successive allocation of new cells until a root cell and a root pointer is reached. The snapshot represents the state of the database at a certain moment in time. In the preferred embodiment, the snapshot is represented by the root pointer value to all data in the database, a data item being indicated as a square In FIG. 3. The value of the root pointer defines the state of the database. For instance, when a given transaction updates the database relating to a given data item indicated as a change from a hatched square to a grid square, the updates are committed, which results to new database cells (squares with a circle) all the way between the modified data item and the upper root cell of the database. A new cell (marked with a grid) is allocated for the modified data item. Thereafter, a new cell Is allocated for each cell containing pointers to new cells containing or being linked to the modified data Item. The process of allocating new cells proceeds for each cell to be modified until the root cell and the root pointer to the database is reached. To summarize, for each cell to be modified a new cell is allocated. The cells above the cell containing the modified data item are updated mainly due to new pointer values.

It is noted that the present invention is not restricted to the preferred embodiment described above, but can be implemented in any database server or management system requiring a concurrency control function. The preferred embodiment may thus vary within the scope of the attached claims.

1. A method for performing concurrency control in a relational database, said method comprising the steps of:
a) obtaining a snapshot of said database for a transaction;
b) generating a checklist of read and/or write events served during a transaction;
c) analyzing concurrent checklists to determine whether they can be serialized;
d) committing said transaction based on the result of said analyzing step; and
e) generating a new snapshot of said database based on the result of said committing step.

2. A method according to claim 1, wherein said analyzing step is based on a checking operation as to whether database elements mentioned in said concurrent checklists are consistent.

3. A method according to claim 2, wherein said checking operation is based on database element identities and/or timestamps collected to said concurrent checklists.

4. A method according to any one of the preceding claim 1, wherein said events are based on a copy-on-write policy.

5. A method according to claim 1, further comprising the steps of requesting a snapshot of said relational database for read-only transactions, returning an updated snapshot for updating transactions, and storing snapshot requests in a snapshot request queue.

6. A method according to claim 5, further comprising the steps of requesting a snapshot in an exclusive mode for an updating transaction request in an autocommit mode, and sending a generated snapshot to the first entry of said snapshot request queue.

7. A method according to claim 6, wherein incoming checklists are queued until no transaction uses said database in an exclusive mode.

8. A method according to claim 1, wherein said analyzing step comprises the step of validating said concurrent checklists against a current database snapshot.

9. A method according to claim 8, wherein said committing step comprises the steps of updating said current database snapshot and reporting successful commitment.

10. A method according to claim 1, comprising the step of discarding additions to said checklist if said checklist exceeds a predetermined length.

11. A system for performing concurrency control in a relational database, said system comprising:
a) managing means (30) for maintaining said relational database based on transaction statements received from clients (50); and
b) transaction means (20-1 to 20-N) for generating a checklist of read and/or write events served during a transaction, and for sending said checklist to said managing means (30) if said transaction request is to be comitted;
c) wherein said managing means (30) is arranged to analyze concurrent checklists to determine whether they can be serialized, and to commit said transaction based on the result of said analyzing step.

12. A system according to claim 11, wherein said manager means (30) is arranged to analyze said concurrent checklists based on a checking operation as to whether database elements mentioned in said concurrent checklists are consistent.

13. A system according to claim 11, wherein said manager means (30) is arranged to validate said concurrent checklists against a current database snapshot, to perform an update of said current snapshot, to discard the old snapshot, and to report successful commitment, if it has not detected any conflict.

14. A system according to claim 11 wherein said system is an SQL-based server.
